(19) United States
(12) Patent Application Publication
(10) Pub. No.: US 2017/0254402 A1
(43) Pub. Date: Sep. 7, 2017

(54) WAVE GENERATOR FOR A STRAIN WAVE GEAR

(71) Applicant: OVALO GmbH, Limburg (DE)

(72) Inventors: Siegmar GILGES, Bad Schwalbach (DE); Tim Frank BUCHHOLZ, Weilmunster (DE)

(21) Appl. No.: 15/449,072

(22) Filed: Mar. 3, 2017

(30) Foreign Application Priority Data
Mar. 4, 2016 (LU) 92987

(51) Int. Cl. F16H 49/00

(52) U.S. Cl. CPC F16H 49/001

(57) ABSTRACT

The invention relates to a wave generator for a strain wave gear, said wave generator in a main portion having a bearing seat for a radially flexible roller bearing. The wave generator is distinguished by having a cone portion that adjoins the main portion in the axial direction and tapers off in a direction away from the main portion.

### CROSS REFERENCE TO RELATED APPLICATIONS

This application claims priority of Luxembourgian patent application number 92987 filed Mar. 4, 2016, the entire disclosure of which is incorporated by reference herein.

### FIELD OF THE INVENTION

The invention relates to a wave generator for a strain wave gear, said wave generator in a main portion having a bearing seat for a radially flexible roller bearing.

The invention moreover relates to a strain wave gear and to a method for manufacturing a strain wave gear.

### BACKGROUND OF THE INVENTION

A strain wave gear in most instances has a rigid gear wheel that in the cross section is circular and has internal toothing, and a flexible gear wheel having external toothing which is disposed in the spatial volume that is surrounded by the rigid gear wheel having internal toothing. A wave generator that in most instances is elliptic is rotatably disposed in the gear wheel having external toothing, the external circumference of said wave generator having a bearing seat for a radially flexible roller bearing. The wave generator by way of the radially flexible roller bearing is in contact with the radially flexible gear wheel having external toothing. The radially flexible roller bearing enables the wave generator to be able to be rotated relative to the radially flexible gear wheel having external toothing. The wave generator bends the roller bearing and the radially flexible gear wheel having external toothing into an elliptic shape so as to cause the toothings of the gear wheel having internal toothing and of the flexible gear wheel having external toothing to mutually engage at each end of the main axis of the ellipse.

The radially flexible gear wheel having external toothing has a lesser number of teeth than the rigid gear wheel having internal toothing. When the wave generator rotates, the external side of the gear wheel having external toothing rolls on the internal side of the rigid gear wheel having internal toothing, wherein the teeth of the flexible gear wheel having external toothing come to engage and to disengage in a revolving manner on opposite sides with the teeth of the rigid gear wheel having internal toothing. By virtue of the difference in the number of the teeth, relative rotation of the radially flexible gear wheel having external toothing relative to the rigid gear wheel having internal toothing arises when the wave generator is rotated. The wave generator does not mandatorily have to be configured so as to be elliptic. Rather, any shape is possible that deviates from the circular shape and as a result effects the described engagement of the toothing of the flexible gear wheel having external toothing in the toothing of the gear wheel having internal toothing. It is also possible for the wave generator to be configured in such a manner that the toothing of the radially flexible gear wheel having external toothing engages in the toothing of the gear wheel having internal toothing at three or more locations.

One difficulty in the manufacturing of a strain wave gear lies in fitting the radially flexible roller bearing onto the bearing seat of the wave generator.

### SUMMARY OF THE INVENTION

It is thus the object of the present invention to state a wave generator for a strain wave gear which enables rapid and efficient assembly of a radially flexible roller bearing.

The object is achieved by a wave generator which is characterized in that the wave generator has a cone portion that adjoins the main portion in the axial direction and tapers off in a direction away from the main portion.

According to the invention, it has been recognized that a main issue in mounting the radially flexible roller bearing onto the wave generator lies in that the roller bearing after the manufacturing thereof in the cross section has a circular shape, while the bearing seat of the wave generator in the cross section has a shape that deviates from the circular shape. The cone portion that adjoins the main portion enables a roller bearing to initially be plug-fitted onto the cone portion in an axial manner and in particular without deforming said roller bearing radially. The roller bearing can subsequently be push-fitted in the axial direction onto the bearing seat of the main portion that is connected to the cone portion, wherein the roller bearing automatically adopts the required shape radially. During push-fitting, the shell area of the cone portion functions as a guide face.

The main portion at least in a part-region which includes the bearing seat is preferably configured as a straight cylinder having a basic shape that differs from that of a circular disk, for example an oval or elliptic basic shape. In the case of a straight cylinder the shell area is at all times perpendicular to the base areas, this being advantageous in order for the shell area to be able to provide the bearing seat.

The cone portion that adjoins the main portion can be configured as a cone or as a truncated cone. In particular, the cone portion can be configured as a straight cone or as a straight truncated cone. On account thereof, an unbalanced mass is avoided when the wave generator is rotated. For example, a straight elliptic cone is a cone having an elliptic base area, in which a straight line that runs perpendicularly through the center of the ellipse also runs through the cone tip. A portion of such a straight elliptic cone that does not comprise the cone tip is a straight truncated elliptic cone.

Preferably, that base area of the cone portion that faces the main portion has the same shape and/or the same size as the base area of the main portion, in particular as the base area of that part-region of the main portion that includes the bearing seat. Moreover, it is advantageous for that base area of the cone portion that faces the main portion to be disposed so as to be parallel with the base area of the main portion and/or so as to be parallel with the base area of that part-region of the main portion that includes the bearing seat.

In the case of one very particularly advantageous embodiment, the cone portion is configured as a truncated cone, wherein the external circumference of that base area of the cone portion that faces away from the main portion is circular. Such an embodiment has the very particular advantage that a roller bearing that after manufacturing thereof is typically circular can be readily plug-fitted onto the free end of the cone portion. The circumference of that base area that faces away from the main face is preferably substantially smaller than the circumference of the bearing seat, and thus smaller than the internal circumference of the internal ring of a roller bearing to be push-fitted, such that the roller bearing can readily be plug-fitted onto the free end of the truncated cone, without the latter having to be widened or deformed.

Alternatively, it is also possible for the cone portion to be configured as a truncated cone, wherein the external circumference of that base area of the cone portion that faces away from the main portion has a shape that deviates from the circular shape. It can be provided herein in particular that the external circumference of that base area of the truncated cone that faces away from the main portion has the same shape as the external circumference of the base area of the main portion and/or as the external circumference of the base area of that part-region of the main portion that includes the bearing seat.

However, that base area of the truncated cone that faces away from the main portion is preferably smaller than the base area of the main portion that includes the bearing seat, in order for the radially flexible roller bearing that after manufacturing thereof is initially circular can be plug-fitted onto the free end of the truncated cone, without said roller bearing having to be widened or deformed. Preferably the largest radial diameter of the free end of the truncated cone is smaller than the internal diameter of the internal ring of the radially flexible roller bearing to be push-fitted.

The external circumference of that base area of the cone portion that faces away from the main portion can be configured so as to be oval, in particular so as to be elliptic.

In the context of this application, in particular in the case of an embodiment that is configured so as to be elliptic, the characteristic radii (largest radius and smallest radius) of the ellipse are referred to as semimajor and semiminor axes, wherein, in an analogous manner, the largest or the smallest radius, respectively, of embodiments of the wave generator that are configured so as to indeed be oval but not elliptic are also referred to using these terms. “Direction of the largest diameter” is understood to be that direction that runs parallel with the largest diameter of an embodiment that is configured so as to be elliptic or oval. “Direction of the smallest diameter” is understood to be that direction that runs parallel with the smallest diameter of an embodiment that is configured so as to be elliptic or oval.

In the case of one very particularly advantageous embodiment, the shell area of the main portion steadily transitions into the shell area of the cone portion. In this way, secure and reliable push-fitting of the roller bearing onto the bearing seat of the main portion is guaranteed. Alternatively or additionally, it can moreover advantageously be provided for this purpose that that base area of the main portion that faces the cone portion and that base area of the cone portion that faces the main portion are aligned so as to be mutually congruent and/or have the same rotational alignment. It is particularly advantageous for the semimajor axis of that base area of the main portion that faces the cone portion and the semimajor axis of that base area of the cone portion that faces the main portion to be aligned so as to be mutually parallel, and/or for the semiminor axis of that base area of the main portion that faces the cone portion and the semiminor axis of that base area of the cone portion that faces the main portion to be aligned so as to be mutually parallel.

Alternatively or additionally, it can also be provided that a direction of the largest diameter of that base area of the main portion that faces the cone portion and a direction of the largest diameter of that base area of the cone portion that faces the main portion are aligned so as to be mutually parallel, and/or that a direction of the smallest diameter of that base area of the main portion that faces the cone portion and a direction of the smallest diameter of that base area of the cone portion that faces the main portion are aligned so as to be mutually parallel.

In the case of one particular embodiment, the main portion has an axial detent that delimits the bearing seat in the axial direction. The axial detent can be configured as an encircling stop ring, for example. In particular, the axial detent together with the remaining parts of the wave generator and/or with the remaining parts of the main portion can be integrally manufactured from the same piece of a semi-finished product.

The axial detent in the cross section can advantageously have a circular external contour. Alternatively, however, it is also possible for the axial detent in the cross section to have an external contour that deviates from the circular shape. Such an embodiment has the advantage that said axial detent can serve for disposing a retaining element for the cone portion in a rotationally correct manner, this advantage to be described in yet more detail further below. In particular, the external contour of the cross section of the axial detent can have the same shape as, but in particular another size than, the external contour of the cross section of the bearing seat. It is also possible for the external contour of the cross section of the axial detent to have the same shape as the external contour of a base area of the cone portion. In particular, the external contour of the cross section of the axial detent can be configured so as to be oval and very particularly elliptic.

The axial detent serves in particular for delimiting the push-fit travel of the roller bearing onto the bearing seat. In particular, it can be advantageously provided that the procedure of pushing the radially flexible roller bearing onto the bearing seat is terminated as soon as the roller bearing, in particular an internal ring of the roller bearing, has reached the axial detent.

In the case of one particular embodiment, the wave generator has an encircling groove, adjacent to the bearing seat, for a lock ring. Such an embodiment has the particular advantage that after push-fitting of the roller bearing onto the bearing seat, this being performed axially along a push-fitting direction, a lock ring, for example a slotted annular spring, can be attached as a further axial detent to that side of the roller bearing that faces away from the axial detent, said lock ring preventing any movement of the radially flexible roller bearing counter to the push-fitting direction, in particular during the later operation of the wave generator as part of a strain wave gear.

In the case of a particularly robust embodiment, the main portion and the cone portion are collectively and integrally manufactured from the same piece of a semi-finished product. In particular in the case of such an embodiment, the cone portion, during a subsequent operation of a strain wave gear, as part of the wave generator remains in the strain wave gear and according to an autonomous and independent inventive concept can assume at least one further function there. In particular in the case of such an embodiment, the cone portion can have a groove for a lock ring. Alternatively or additionally, it is also possible for the cone portion after push-fitting of the roller bearing to function as a carrier for a seal for the roller bearing, or to carry a detent seam for further components. Alternatively or additionally, it is also possible for the cone portion to have a face for a DMC marking code and/or a coupling face for third-party elements.

Alternatively, the wave generator according to the invention can also be configured from multiple parts, wherein, in particular, at least one part can be formed by the main portion and another part can be formed by the cone portion.

The plurality of parts of the wave generator, in particular the main portion and the cone portion, can be non-releasably interconnected, in particular interconnected in a materially integral manner.

Alternatively, the parts, in particular the main portion and the cone portion, can also be releasably interconnected, this having the advantage of being able to remove the cone portion again, in particular after push-fitting of one or a plurality of radially flexible roller bearings onto the bearing seat. This for the purpose of being able to subsequently use the cone portion on another main portion for push-fitting a radially flexible roller bearing onto the other main portion, for example.

However, it is important to guarantee that the cone portion is at all times connected to the main portion in a rotationally correct manner, so as to enable efficient and trouble-free push-fitting of a radially flexible roller bearing. To this end, it can be provided in particular, for example, that the main portion has a plug-fit element, and that the cone portion has a plug-fit counter element, wherein the plug-fit element and the plug-fit counter element are configured so as to be complementary in terms of shape.

In particular, the plug-fit element and the plug-fit counter element can advantageously be configured in such a manner that after establishment of the plug-fit connection the main portion is automatically aligned with the core portion in such a manner that that base area of the main portion that faces the cone portion and that base area of the cone portion that faces the main portion are aligned so as to be mutually congruent and/or have the same rotational alignment and/or are aligned so as to be mutually parallel.

In particular, it can be advantageously provided that the plug-fit element and the plug-fit counter element are configured in such a manner that after establishment of the plug-fit connection the main portion is automatically aligned with the cone portion in such a manner that a semimajor axis of that base area of the main portion that faces the cone portion and a semimajor axis of that base area of the cone portion that faces the main portion are aligned so as to be mutually parallel, and/or that a semiminor axis of that base area of the main portion that faces the cone portion and a semiminor axis of that base area of the cone portion that faces the main portion are aligned so as to be mutually parallel.

Alternatively or additionally, it can also be provided that the plug-fit element and the plug-fit counter element are configured in such a manner that after establishment of the plug-fit connection the main portion is automatically aligned with the cone portion in such a manner that a direction of the largest diameter of that base area of the main portion that faces the cone portion and a direction of the largest diameter of that base area of the cone portion that faces the main portion are aligned so as to be mutually parallel, and/or that a direction of the smallest diameter of that base area of the main portion that faces the cone portion and a direction of the smallest diameter of that base area of the cone portion that faces the main portion are aligned so as to be mutually parallel.

In the case of one particular embodiment, the plug-fit element is disposed on that base area of the main portion that faces the cone portion. It is also possible for the plug-fit counter element to be disposed on that base area of the cone portion that faces the main portion.

In the case of one particularly advantageous embodiment, the plug-fit element and/or the plug-fit counter element in the cross section have/has an external contour that deviates from the circular shape. In particular, it can be advantageously provided that the plug-fit element and/or the plug-fit counter element in the cross section are/is configured so as to be oval, in particular so as to be elliptic. Such an embodiment advantageously enables a plug-fit connection between the main portion and the cone portion to be established rapidly and efficiently. In particular, it can be advantageously additionally provided herein that the plug-fit element and the plug-fit counter element are configured so as to be conical in order to achieve radial self-centering during assembly by plug-fitting.

It is also possible for the plug-fit element and/or the plug-fit counter element in the cross section to have an external contour different from the main portion. Alternatively, it is also possible for the plug-fit element and/or the plug-fit counter element in the cross section to have the same external contour as the main portion, wherein, however, the directions of the largest diameter are dissimilar, and/or for the plug-fit element and/or the plug-fit counter element in the cross section to have the same external contour as the main portion, wherein, however, the directions of the smallest diameter are dissimilar.

In the case of one very particularly advantageous embodiment, the plug-fit element is formed by the external contour of that base area of the main portion that faces away from the cone portion, and/or is formed by the axial detent. In particular in the case of such an embodiment, a retaining element, which is connectable to or is connected to the cone portion, in particular exclusively in one specific rotational alignment, can have the plug-fit counter element. In particular, the retaining element can be connected temporarily to the cone portion (and, in this regard, is configured so as to be connectable to the cone portion) until the roller bearing is push-fitted onto the bearing seat.

In particular, in the case of an embodiment in which the wave generator is configured as a hollow shaft or as a hollow wheel, a retaining element of this type can be disposed on that side of the main portion that faces away from the cone portion and can be connected to the cone portion through the main portion, so as to at least temporarily fix the cone portion to the main portion in a rotationally correct manner.

Very generally, it can advantageously be provided that the main portion is clamped between a retaining element and the cone portion, so as to at least temporarily fix the cone portion to the main portion. It can be provided herein that means which enable a rotationally correct alignment of the cone portion, in particular by way of a rotationally correct alignment of the retaining element, are available. To this extent, it can advantageously be provided that the main portion, the retaining element, and the cone portion are configured in such a manner that the main portion can be clamped, that is to say is clampable, between the retaining element and the cone portion.

A strain wave gear which includes a wave generator according to the invention, or includes at least the main portion of a wave generator according to the invention, is of particular advantage, a radially flexible roller bearing having been press-fitted onto the bearing seat of said wave generator while using the shell area of the cone portion as a guide face. It can be provided in particular herein that the cone portion has been removed and that the main portion is installed without the cone portion in the strain wave gear. However, the main portion that is installed in the strain wave gear can advantageously have a plug-fit element as before, which when press-fitting the roller bearing was operatively connected to a plug-fit counter element of the cone portion or to a plug-fit counter element of a retaining element, in order for the cone portion to be temporarily fastened.

In particular, it can be advantageously provided that the strain wave gear has at least one roller bearing that is press-fitted onto the bearing seat in the above-described way. In particular, it can advantageously also be provided that two or more roller bearings are simultaneously or sequentially press-fitted onto the bearing seat by way of the cone portion.

In particular, it can advantageously be provided that the cone portion of the wave generator and optionally further components that served for temporarily fastening the cone portion to the main portion, after push-fitting of the roller bearing onto the bearing seat, are removed, the wave generator being installed without the cone portion and without the optionally available further components in the strain wave gear to be manufactured.

A roller bearing to be press-fitted can be configured in particular as a ball bearing having an internal ring and an external ring. The internal ring can advantageously be dimensioned in such a manner that the former, after push-fitting onto the bearing seat in the tangential direction, is retained exclusively by a friction fit. To this extent, it can advantageously be provided that the internal circumference of the internal ring of the roller bearing corresponds to the external circumference of the bearing seat.

### BRIEF DESCRIPTION OF THE DRAWING VIEWS

The subject matter of the invention is shown in an exemplary and schematic manner in the drawing and will be described hereunder by means of the figures, wherein the same elements or elements with the same function are in most instances also provided with the same reference signs in the various exemplary embodiments. In the drawing:

FIGS. 1 to 3 show a first exemplary embodiment of a wave generator according to the invention in various views and in various phases when push-fitting a radially flexible roller bearing;

FIGS. 4 to 6 show a second exemplary embodiment of a wave generator according to the invention in various views and in various phases when push-fitting a radially flexible roller bearing;

FIGS. 7 to 9 show a third exemplary embodiment of a wave generator according to the invention in various views and in various phases when push-fitting two radially flexible roller bearings;

FIGS. 10 to 12 show a fourth exemplary embodiment of a wave generator according to the invention in various views and in various phases when push-fitting two radially flexible roller bearings;

FIGS. 13 to 16 show a fifth exemplary embodiment of a wave generator according to the invention in various views and in various phases prior to, during, and after push-fitting a radially flexible roller bearing, wherein FIGS. 13 and 16 show the exemplary embodiment without the tapered-off cone portion; and

FIGS. 17 to 20 show a sixth exemplary embodiment of a wave generator according to the invention in various views and in various phases prior to, during, and after push-fitting a radially flexible roller bearing, wherein FIG. 17 shows the exemplary embodiment without the tapered-off cone portion.

### DETAILED DESCRIPTION OF THE INVENTION

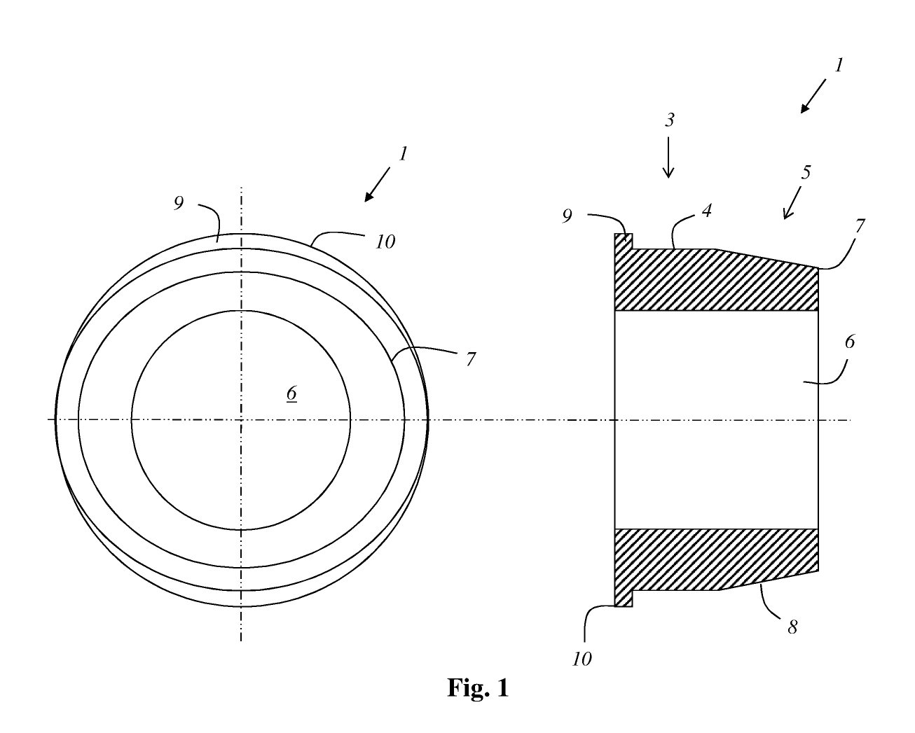

FIGS. 1 to 3 show a first exemplary embodiment of a wave generator 1 according to the invention in various views and in various phases when push-fitting a radially flexible roller bearing 2.

FIG. 1 in the right illustration shows a cross section through the wave generator 1 along the axial direction. The wave generator 1 in a main portion 3 has a bearing seat 4 for a radially flexible roller bearing 2. The wave generator 1 moreover has a cone portion 5 that adjoins the main portion 3 in the axial direction and tapers off in a direction away from the main portion 3. The wave generator 1 is configured as a hollow shaft and accordingly has a through bore 6 that runs in the axial direction.

The main portion 3 is configured as a straight cylinder having a basic shape that differs from that of a circular disk, specifically having an elliptic basic shape, in that part-region that includes the bearing seat 4.

Specifically, the cone portion 5 is configured as a straight truncated cone, wherein that base area of the cone portion that faces the main portion 3 has the same elliptic shape and the same size as the base area of the main portion 3 in that part-region in which the bearing seat 4 is disposed. The external circumference 7 of that base area of the cone portion 5 that faces away from the main portion 3 in the case of this exemplary embodiment is configured so as to be circular. The through bore 6 in the cross section is also configured so as to be circular.

Proceeding from the free end of the cone portion 5 toward that end of the cone portion 5 that faces the main portion 3, the cross-sectional shape of the external contour of the shell area 8 of the cone portion 5 changes from a circular shape to an elliptic shape. The shell area 8 of the cone portion 5 steadily transitions into the shell area of that part of the main portion 3 that has the bearing seat 4.

The main portion 3 has an axial detent 9 that delimits the bearing seat 4 in the axial direction. The axial detent 9 in the case of this exemplary embodiment has an external contour 10 that in the cross section is circular.

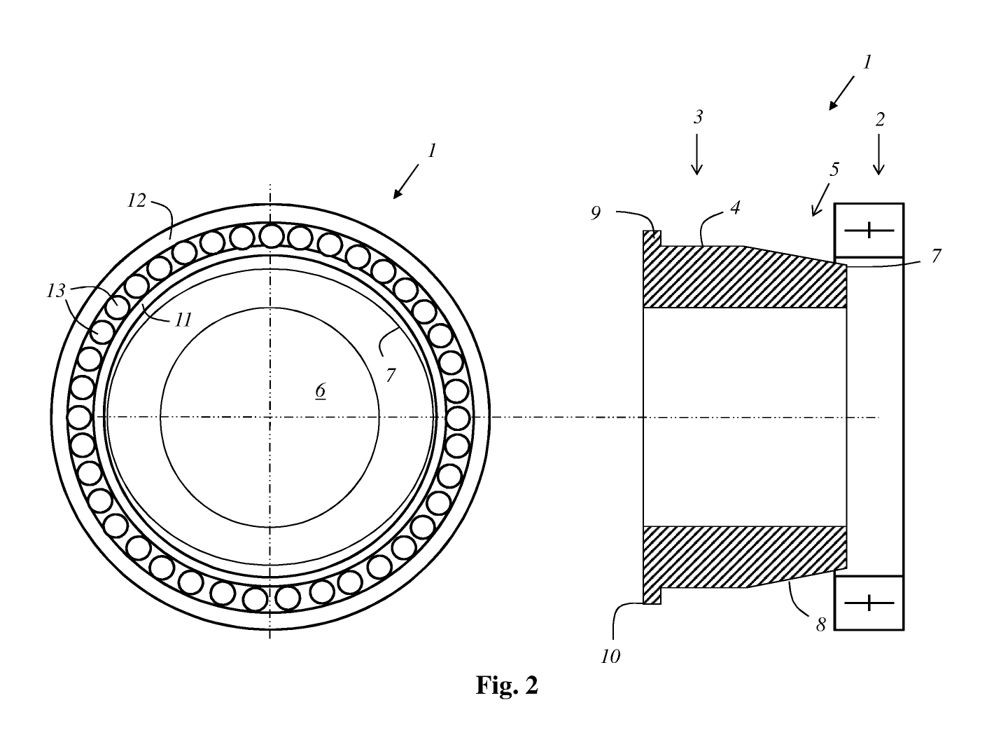

FIG. 2 shows the first exemplary embodiment of a wave generator 1 according to the invention, having a radially flexible roller bearing 2 that is loosely plug-fitted onto the free end of the cone portion 5 and that can be configured as a ball bearing, for example. The radially flexible roller bearing 2 in the case of this exemplary embodiment has an internal ring 11 and an external ring 12. Bearing balls 13 are disposed between the internal ring 11 and the external ring 12.

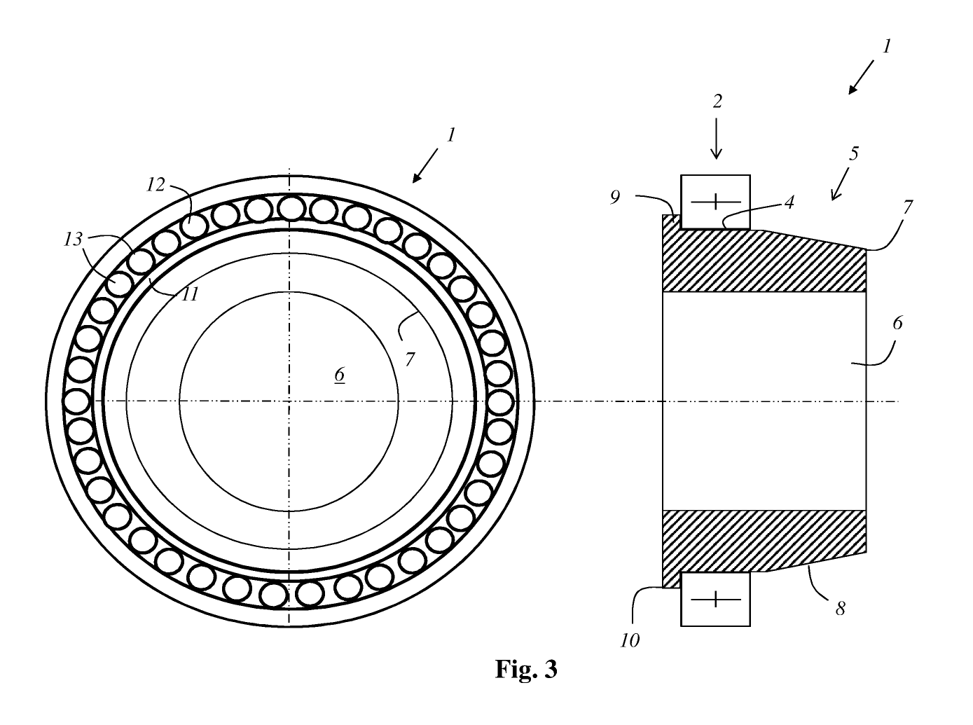

In a subsequent operational step, the radially flexible roller bearing 2 by way of the shell area 8 of the cone portion 5, which serves as a guide face, is push-fitted onto the main portion 3, specifically onto that part of the main portion 3 that has the bearing seat 4, until the radially flexible roller bearing 2 impacts the axial detent 9. Herein, the radially flexible roller bearing 2 is deformed from an initially circular shape to an elliptic shape. Finally, the push-fitted radially flexible roller bearing 2 is connected in a friction-fitting manner to the main portion 3 of the wave generator 1. This is illustrated in FIG. 3.

While the illustrations of FIGS. 1 to 3 that in each case are on the right show a cross section along the axial direction, the illustrations of FIGS. 1 to 3 that in each case are on the left show a plan view along the axial push-fitting direction.

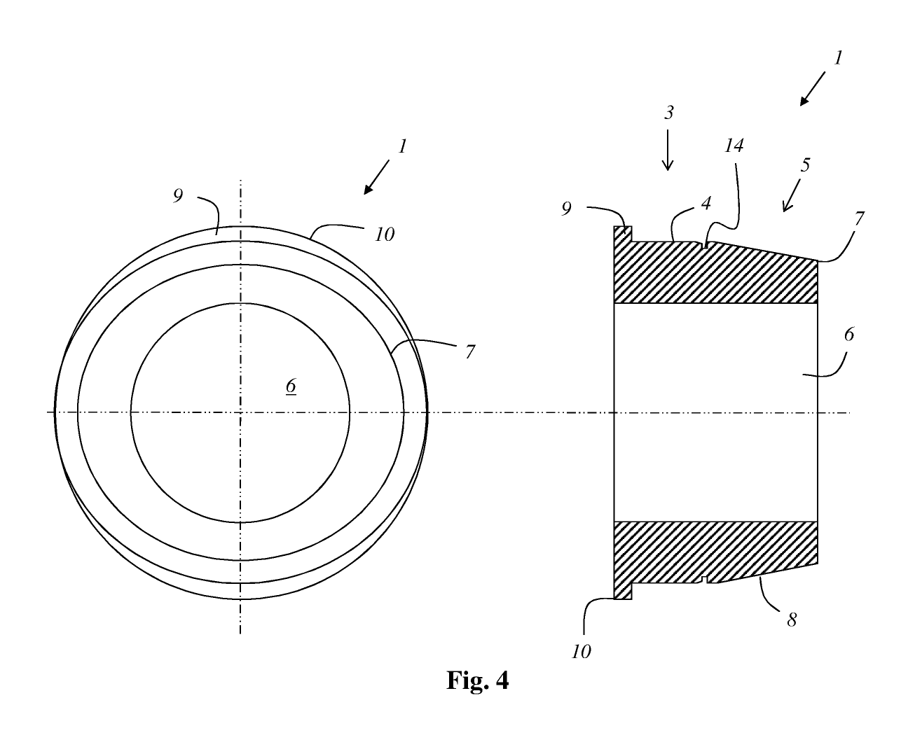

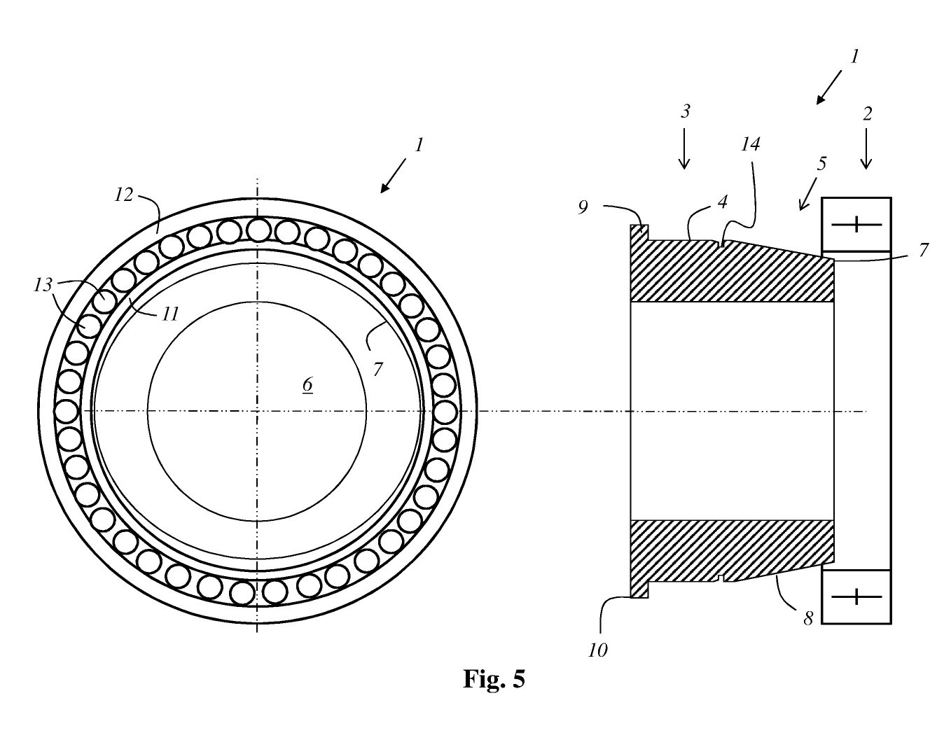

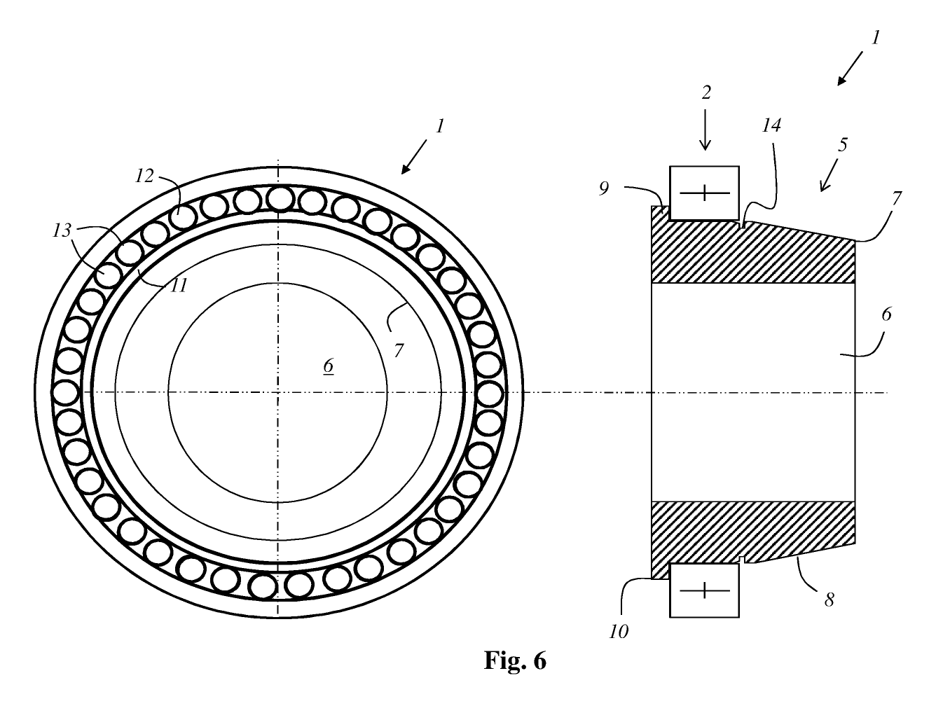

FIGS. 4 to 6 show a second exemplary embodiment of a wave generator 1 according to the invention in various views and in various phases when push-fitting a radially flexible roller bearing 2. This embodiment differs from the embodiment shown in FIGS. 1 to 3 in that the former has an encircling groove 14, adjacent to the bearing seat 4, for a lock ring (not illustrated). After push-fitting a radially flexible roller bearing 2 onto the bearing seat 4, a lock ring, for example in the form of a slotted annular spring, can be inserted into the groove. To this end, the lock ring can initially be plug-fitted onto the free end of the cone portion 5 and then push-fitted so far until the former latches into the groove 14. The shell area 8 of the cone portion 5 herein can advantageously function as a guide face. The lock ring prevents the radially flexible roller bearing 2 from sliding off the bearing seat 4 counter to the push-fitting direction, in particular during the later operation in a strain wave gear.

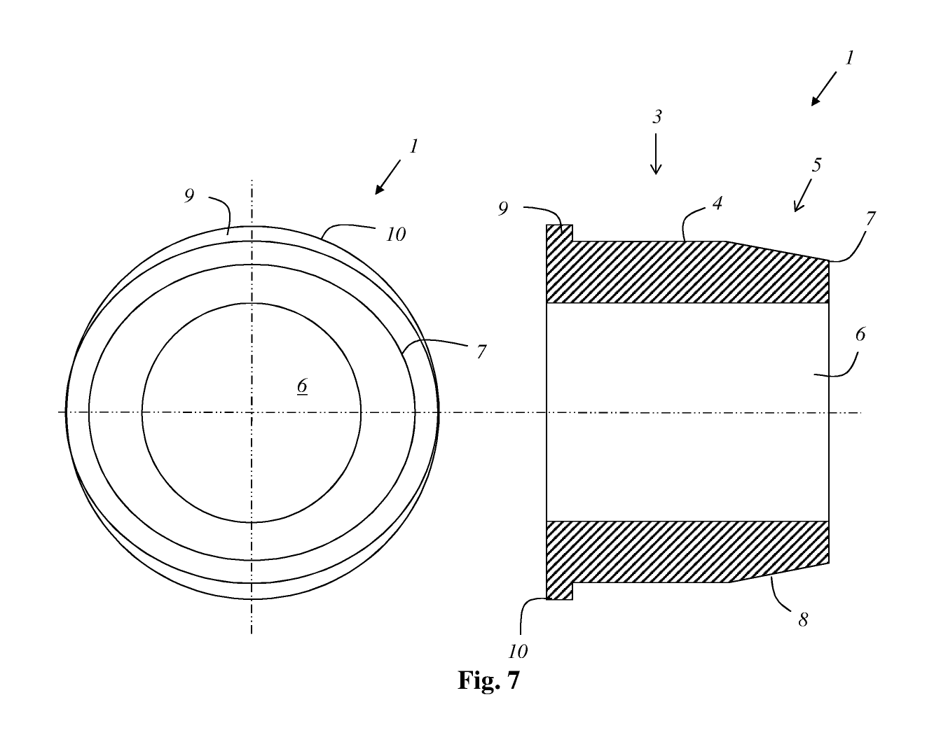

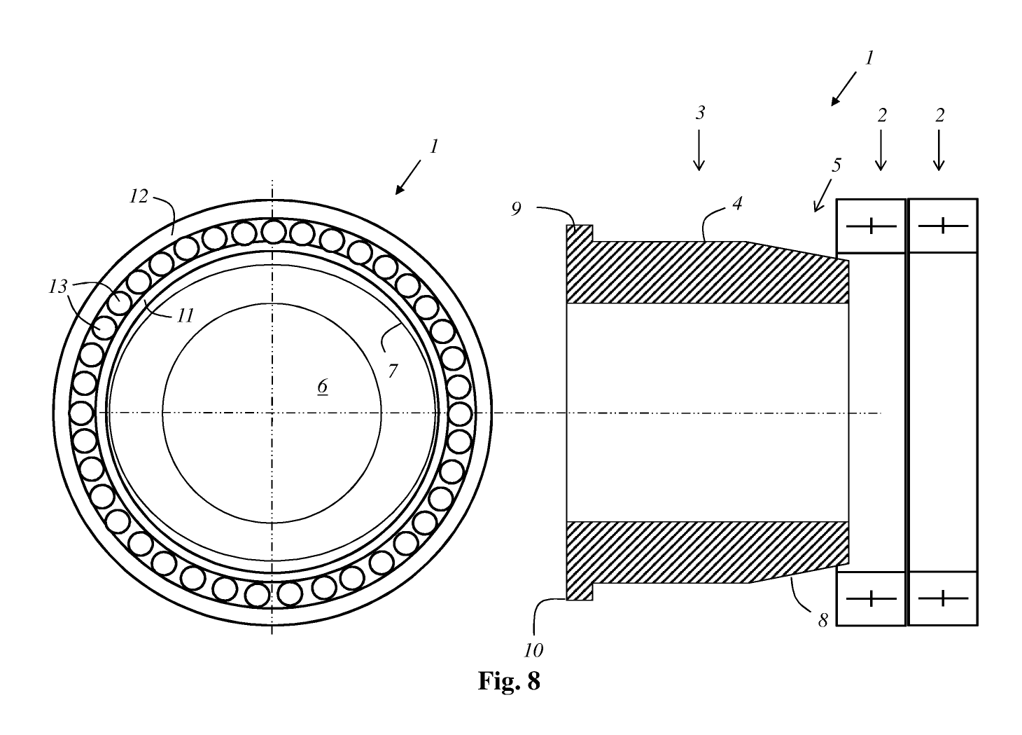

FIGS. 7 to 9 show a third exemplary embodiment of a wave generator according to the invention in various views and in various phases when push-fitting two radially flexible roller bearings 2. This exemplary embodiment differs from the exemplary embodiment illustrated in FIGS. 1 to 3 by way of an axially wider bearing seat for two mutually parallel radially flexible roller bearings 2.

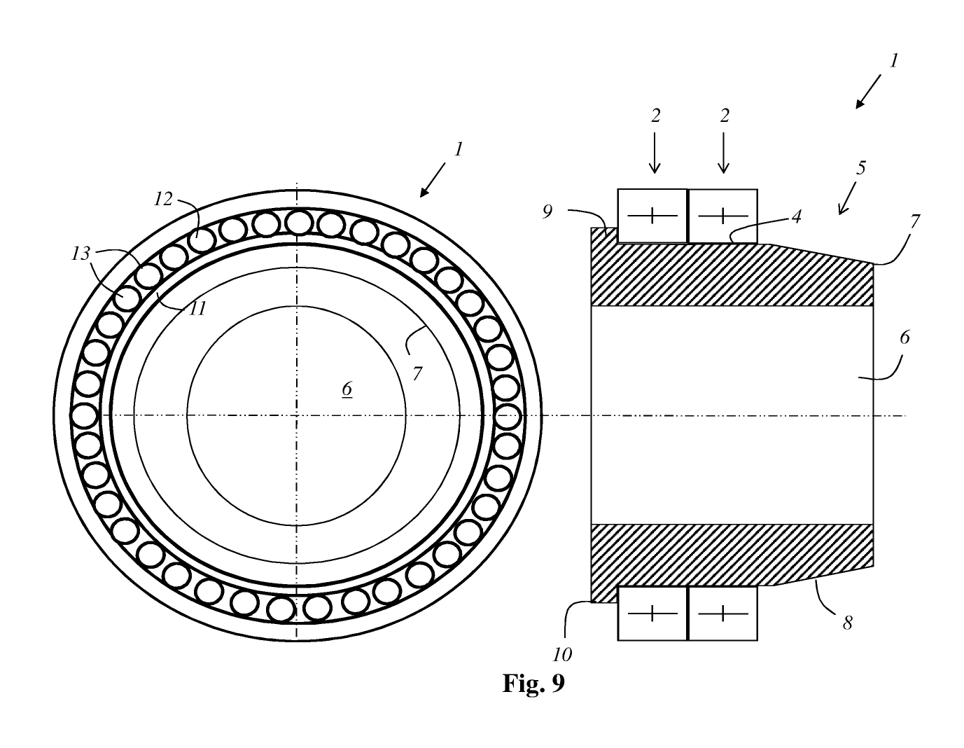

Both radially flexible roller bearings 2 can be simultaneously push-fitted, for example. To this end, both radially flexible roller bearings 2 are initially plug-fitted onto the free end of the cone portion 5 and, utilizing the shell area 8 of the cone portion 5 as a guide face, subsequently collectively push-fitted onto the main portion 3 until the axial detent 9 is reached. This situation is illustrated in FIG. 9.

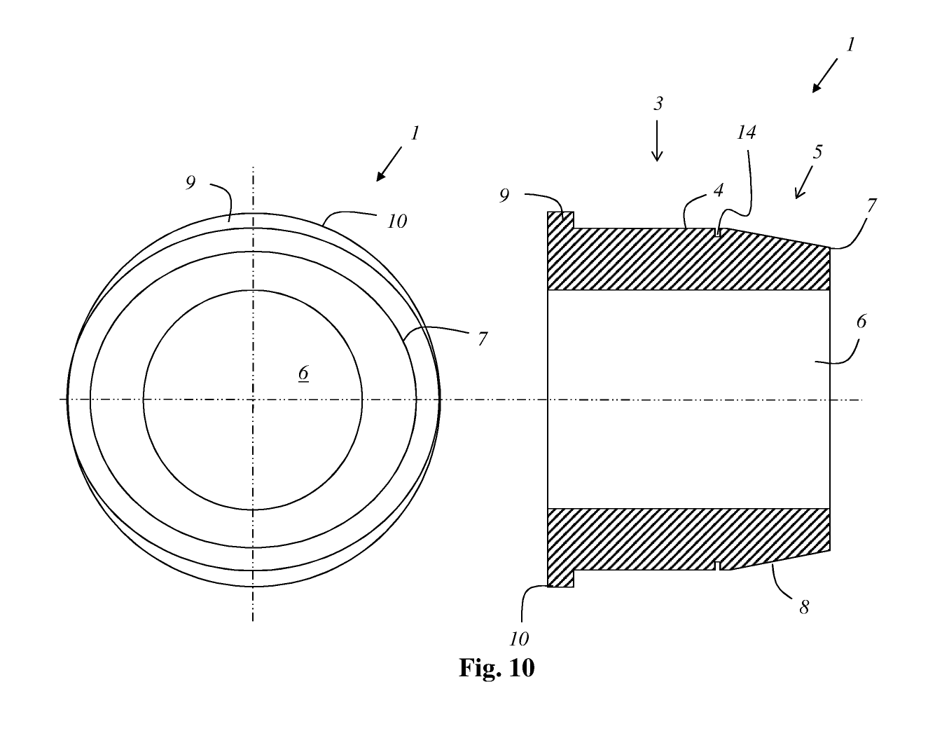

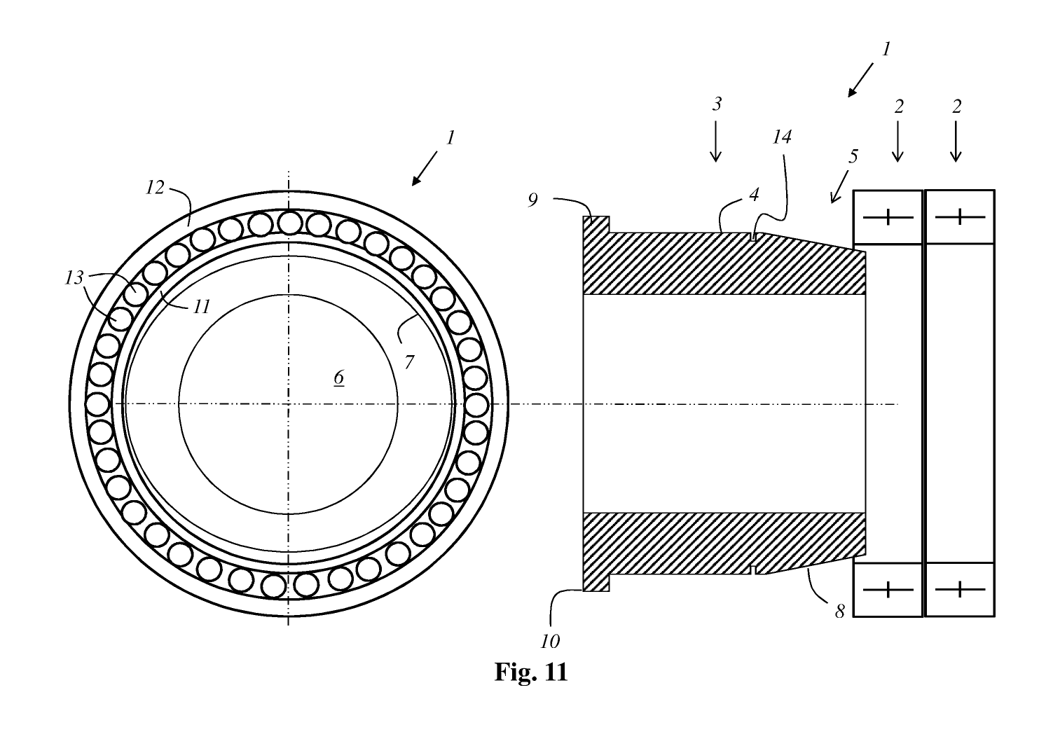

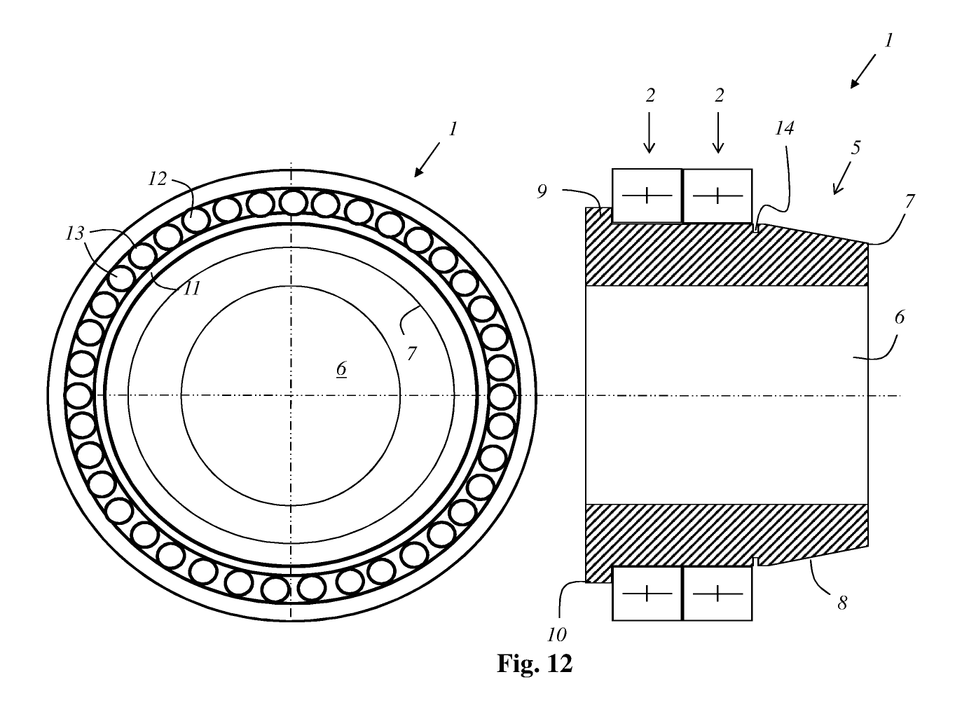

FIGS. 10 to 12 show a fourth exemplary embodiment of a wave generator 1 according to the invention in various views and in various phases when push-fitting two radially flexible roller bearings, wherein this exemplary embodiment differs from the exemplary embodiment illustrated in FIGS. 7 to 9 in that a groove 14 for a lock ring is available between the bearing seat 4 and the cone portion 5.

After push-fitting the radially flexible roller bearing 2 onto the bearing seat 4, a lock ring, for example in the form of a slotted annular spring, can be inserted into the groove. To this end, the lock ring can initially be plug-fitted onto the free end of the cone portion 5 and then push-fitted so far until the former latches into the groove 14. The shell area 8 of the cone portion 5 herein can advantageously function as a guide face. The lock ring prevents the radially flexible roller bearing 2 from sliding off the bearing seat 4 counter to the push-fitting direction, in particular during the later operation in a strain wave gear.

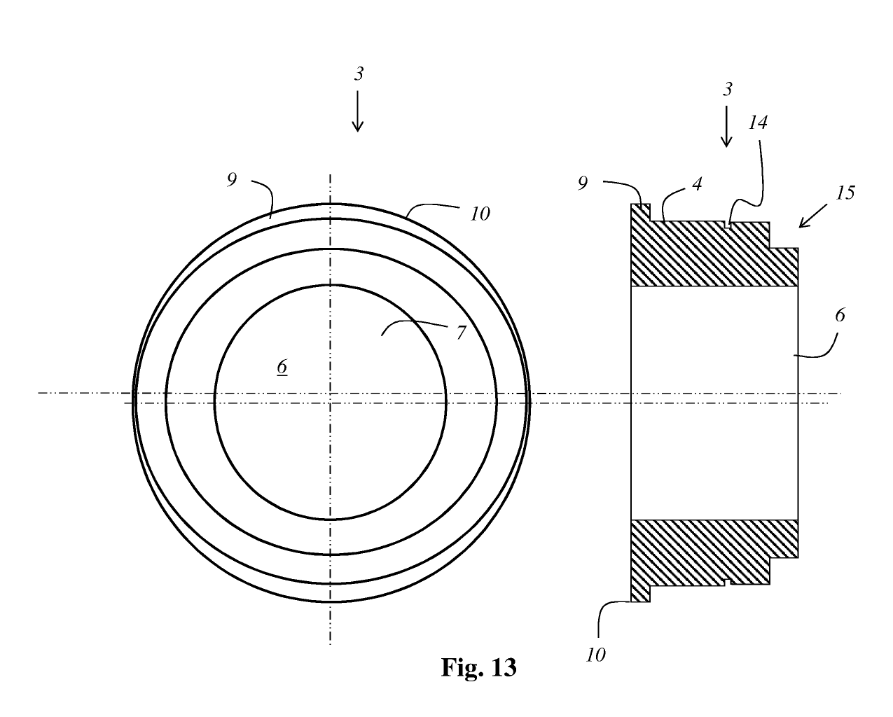

FIGS. 13 to 16 show a fifth exemplary embodiment of a wave generator 1 according to the invention in various phases prior to, during, and after push-fitting a radially flexible roller bearing 2.

FIG. 13 shows the main portion 3 of a wave generator 1 according to the invention. The main portion 3 has a bearing seat 4 for a radially flexible roller bearing 2, said bearing seat 4 being delimited in the axial direction by an axial detent 9. Moreover, the main portion 3, axially beside the bearing seat 4, has an encircling groove 14 for a lock ring (not illustrated).

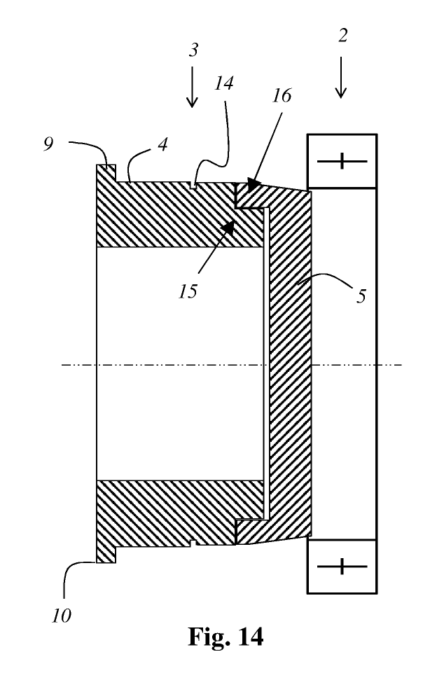

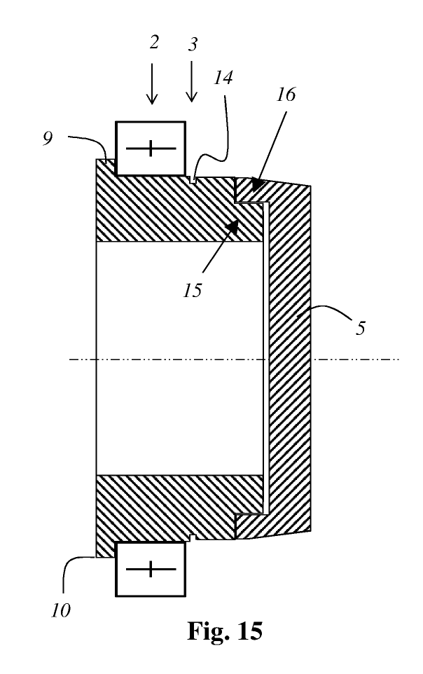

The main portion 3 moreover has a plug-fit element 15 that in the cross section is oval and is configured for interacting with a plug-fit counter element 16 of the cone portion 5 that is configured so as to be complementary in terms of shape, said cone portion 5 being shown only in FIGS. 14 and 15.

FIG. 14 shows the wave generator 1 that is configured in multiple parts in an assembled plug-fitted state. The plug-fit element 15 and the plug-fit counter element 16 are configured in such a manner that after establishment of the plug-fit connection the main portion 3 is automatically aligned with the cone portion 5 in such a manner that that base area of the main portion 3 that faces the cone portion 5 and that base area of the cone portion 5 that faces the main portion 3 are aligned and disposed so as to be mutually congruent. On account thereof it is guaranteed that the shell area 8 of the cone portion 5 steadily transitions into that external circumferential area of the main portion 3 that includes the bearing seat 4.

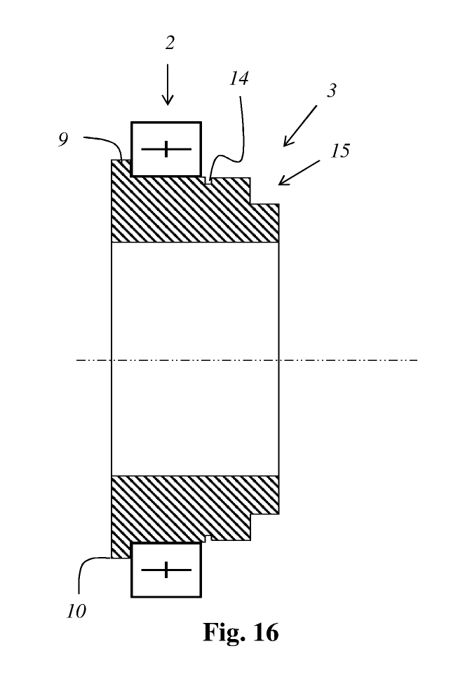

FIG. 14 moreover shows a radially flexible roller bearing 2 that is to be push-fitted and that also in the case of this embodiment is initially plug-fitted onto the free end of the cone portion 5 in the manner as has already been described multiple times above. Push-fitting the radially flexible roller bearing 2 onto the bearing seat 4 of the main portion 3 until the axial detent 9 is reached is subsequently performed. This situation is illustrated in FIG. 15. After push-fitting the radially flexible roller bearing 2, the cone portion 5 can be separated from the main portion 3, this being illustrated in FIG. 16, or can be used in the manner illustrated in FIG. 15 in a strain wave gear.

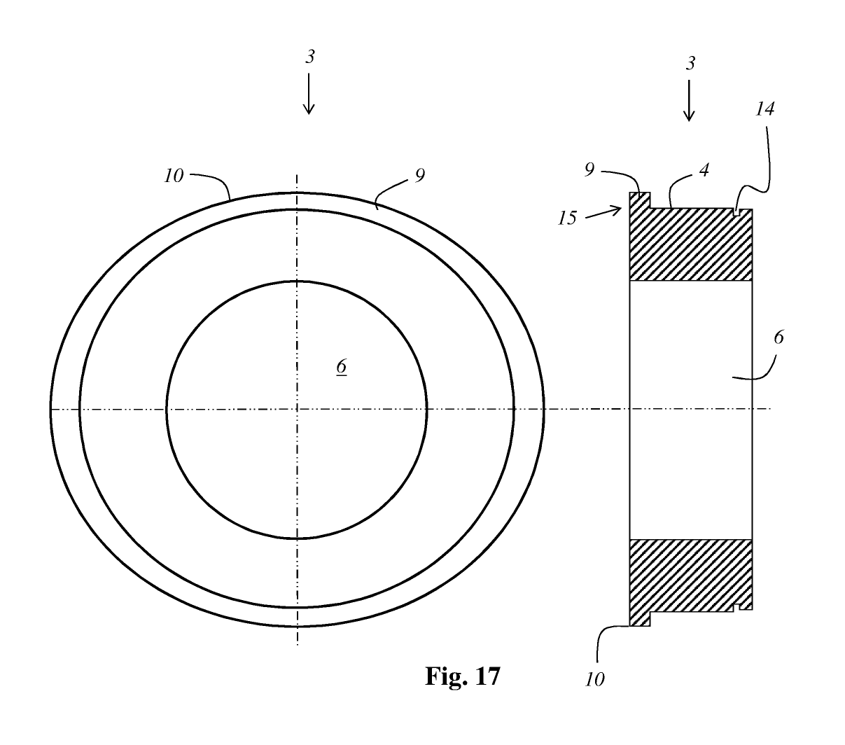

FIGS. 17 to 20 illustrate a sixth exemplary embodiment of a wave generator according to the invention in various phases prior to, during, and after push-fitting a radially flexible roller bearing.

FIG. 17 shows the main portion 3 of a multiple-part wave generator 1, wherein the cone portion is not illustrated in FIG. 17. The main portion 3 has a bearing seat 4, an axial detent 9, on the one hand, and a groove 14 for a lock ring, on the other hand, being adjacent to the former. The main portion 3 is configured as a hollow shaft having an axial through bore 6.

That part of the main portion 3 that has the bearing seat 4 in the cross section is externally configured so as to be elliptic, this being identifiable in the left illustration of FIG. 17.

The axial detent 9 in the case of this exemplary embodiment in the cross section has an external contour that deviates from the circular shape. Specifically, the external contour 10 of the axial detent 9 in the case of this exemplary embodiment in the cross section is configured so as to be elliptic, this likewise being identifiable in the left illustration of FIG. 17.

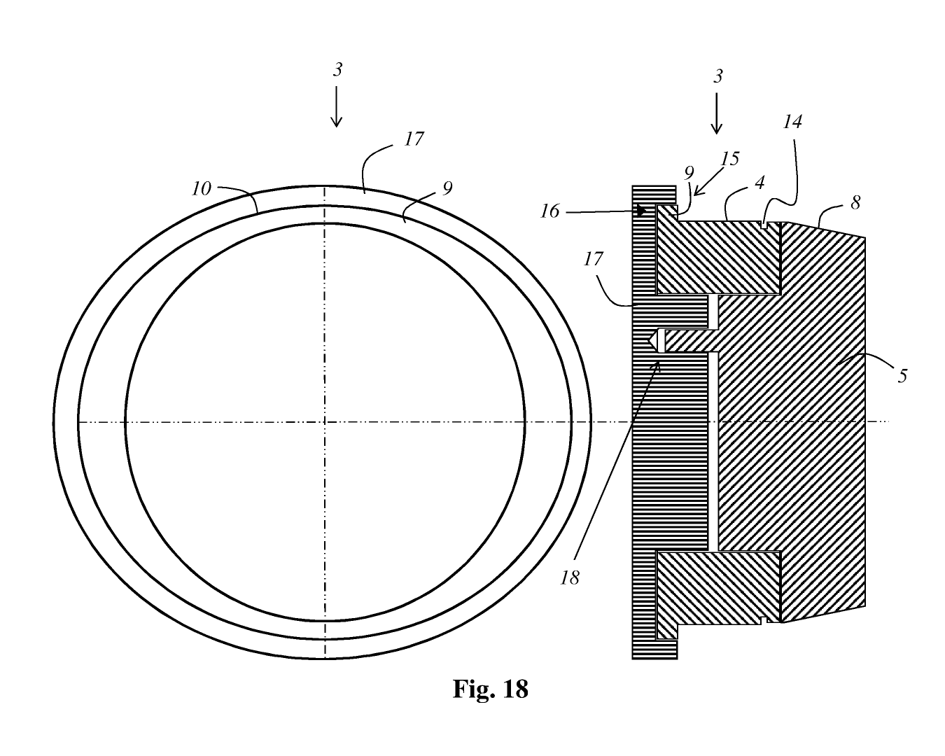

In the case of this exemplary embodiment the axial detent 9 forms a plug-fit element 15 for a retaining element 17 (illustrated in FIGS. 18 to 20) which on that side thereof that faces the main portion 3 has the plug-fit counter element 16 which has an internal contour that deviates from the circular shape and guarantees rotationally correct attaching of the retaining element 17 to the main portion 3. Specifically, the retaining element 17 is configured so as to be complementary in terms of shape to the external side of the axial detent 9, such that the retaining element 17 (by virtue of the elliptic symmetry) can only be plug-fitted onto the main portion 3 in two mutually equivalent rotational positions. Fastening of the cone portion 5 is performed in that the main portion 3 is disposed between the retaining element 17 and the cone portion 5. A further plug-fit connection 18 is available for connecting the cone portion 5 to the retaining element 17. The plug-fit connection 18 is disposed so as to be offset in relation to the axial central axis, on account of which it is guaranteed that the cone portion 5 is disposed so as to be automatically rotationally correct in relation to the retaining element and thus so as to be rotationally correct in relation to the main portion 3. The shell area 8 of the cone portion 5, also in the case of this exemplary embodiment, steadily transitions into an external circumferential area of the main portion 3 that includes the bearing seat 4.

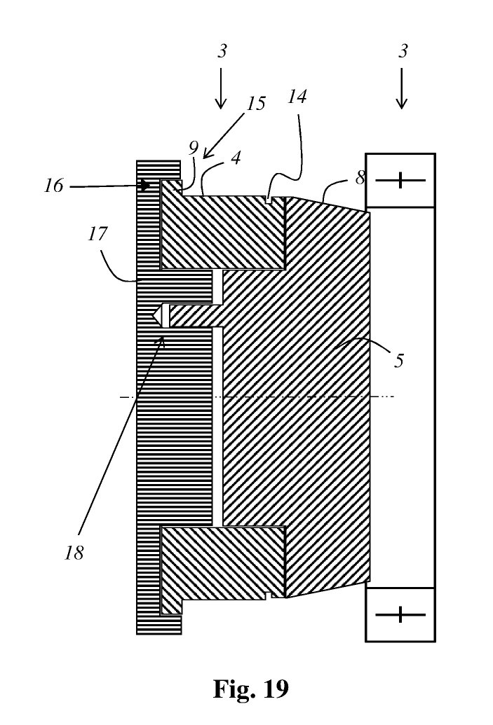

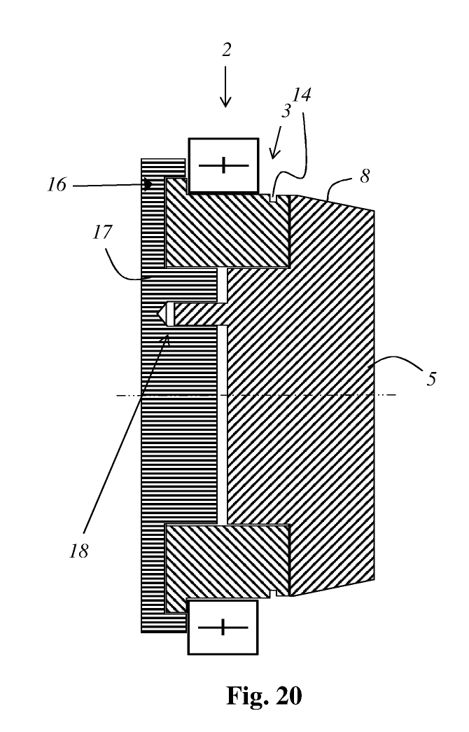

Push-fitting a radially flexible roller bearing 2 is performed in the way as has already been described multiple times above in such a manner that the radially flexible roller bearing 2 is initially plug-fitted onto the free end of the cone portion 5, this being illustrated in FIG. 19. Push-fitting the radially flexible roller bearing 2 onto the main portion 3 until the radially flexible roller bearing 2 has reached the axial detent 9 is subsequently performed, this being illustrated in FIG. 20. Thereafter, the retaining element 17 and the cone portion 5 can be removed, or the wave generator can be used in the manner illustrated in FIG. 20 in a strain wave gear.

Exactly as is the case in the exemplary embodiment illustrated in FIGS. 13 to 16, also in the case of this exemplary embodiment only the main portion 3 that is provided with a radially flexible roller bearing 2 is installed in a strain wave gear, while the cone portion 5 can be re-used for push-fitting a radially flexible roller bearing 2 in the case of another main portion 3.

### LIST OF REFERENCE SIGNS

1 Wave generator

2 Radially flexible roller bearing

3 Main portion

4 Bearing seat

5 Cone portion

6 Through bore

7 External circumference

8 Shell area

9 Axial detent

10 External contour of the axial detent 9

11 Internal ring

12 External ring

13 Bearing balls

14 Encircling groove

15 Plug-fit element

16 Plug-fit counter element

17 Retaining element

18 Further plug-fit connection

What is claimed is:

1. A wave generator for a strain wave gear, said wave generator comprising a main portion including a bearing seat for a radially flexible roller bearing, wherein the wave generator further comprises a cone portion adjoining the main portion in an axial direction, wherein the cone potion tapers in a direction away from the main portion.

2. The wave generator as claimed in claim 1, wherein the main portion at least in a part-region thereof which includes the bearing seat is configured as a straight cylinder having a basic shape that differs from that of a circular disk.

3. The wave generator as claimed in claim 2, wherein the main portion at least in a part-region thereof which includes the bearing seat is configured as a straight cylinder having an oval or elliptic basic shape.

4. The wave generator as claimed in claim 1, wherein the cone portion is configured as a cone or as a truncated cone or as a straight cone or as a straight truncated cone.

5. The wave generator as claimed in claim 2, wherein the main portion includes i) a base area facing the cone portion and ii) a seat region base area of the part-region which includes the bearing seat, and the cone portion includes a base area facing the main portion, wherein the base area of the cone portion has the same shape and/or the same size as the base area of the main portion and/or as the seat region base area.

6. The wave generator as claimed in claim 5, wherein the base area of the cone portion is parallel to the base area of the main portion and/or to the seat region base area.

7. The wave generator as claimed in claim 5, wherein the cone portion is configured as a truncated cone, and wherein an external circumference of the base area of the cone portion is circular.

8. The wave generator as claimed in claim 5, wherein the cone portion is configured as a truncated cone, and wherein
a. an external circumference of the base area of the cone portion is non-circular, or wherein
b. an external circumference of the base area of the cone portion has the same shape as an external circumference of the base area of the main portion or as an external circumference of the seat region base area, or wherein
c. an external circumference of the base area of the cone portion is oval, or wherein
d. an external circumference of that base area of the cone portion is elliptic.

9. The wave generator as claimed in claim 1, wherein a shell area of the main portion steadily transitions into a shell area of the cone portion.

10. The wave generator as claimed in claim 5, wherein
a. the base area of the main portion and the base area of the cone portion are aligned so as to be mutually congruent, and/or wherein
b. the base area of the main portion and the base area of the cone portion have the same rotational alignment, and/or wherein
c. a semimajor axis of the base area of the main portion and a semimajor axis of the base area of the cone portion are aligned so as to be mutually parallel, and/or wherein
d. a semiminor axis of the base area of the main portion and a semiminor axis of the base area of the cone portion are aligned so as to be mutually parallel, and/or wherein
e. a direction of a largest diameter of the base area of the main portion and a direction of a largest diameter of the base area of the cone portion are aligned so as to be mutually parallel, and/or wherein
f. a direction of a smallest diameter of the base area of the main portion and a direction of a smallest diameter of the base area of the cone portion are aligned so as to be mutually parallel.

11. The wave generator as claimed in claim 1, wherein the main portion has an axial detent that delimits the bearing seat in the axial direction.

12. The wave generator as claimed in claim 11, wherein the axial detent has a circular external contour in cross section.

13. The wave generator as claimed in claim 11, wherein
a. the axial detent has a non-circular external contour in cross section, or wherein
b. an external contour of the axial detent in cross section has the same shape as an external contour of the bearing seat in cross section, or wherein
c. an external contour of the axial detent in cross section has the same shape as the external contour of a base area of the cone portion, or wherein
d. an external contour of the axial detent in cross section is oval, or wherein
e. an external contour of the axial detent in cross section is elliptic.

14. The wave generator as claimed in claim 1, further comprising
a. an encircling groove, adjacent to the bearing seat, for a lock ring, and/or
b. an encircling groove, adjacent to the bearing seat, and a lock ring disposed in the encircling groove.

15. The wave generator as claimed in claim 1, wherein the main portion and the cone portion are collectively and integrally manufactured from the same piece of a semi-finished product.

16. The wave generator as claimed in claim 1, wherein the wave generator is configured from multiple parts, wherein a first part of the multiple parts includes the main portion and a second part of the multiple parts includes the cone portion.

17. The wave generator as claimed in claim 16, wherein the first part and the second part are non-releasably interconnected.

18. The wave generator as claimed in claim 16, wherein the first part and the second part are releasably interconnected.

19. The wave generator as claimed in claim 16, wherein the main portion has a plug-fit element, and wherein the cone portion has a plug-fit counter element, wherein the plug-fit element and the plug-fit counter element are complementary in shape, whereby the main portion and cone portion are interconnected by a plug-fit connection.

20. The wave generator as claimed in claim 19, wherein the plug-fit element and the plug-fit counter element are configured such that after establishment of the plug-fit connection the main portion is automatically aligned with the cone portion such that
a. a base area of the main portion that faces the cone portion and a base area of the cone portion that faces the main portion are aligned so as to be mutually congruent, and/or that
b. a base area of the main portion that faces the cone portion and a base area of the cone portion that faces the main portion have the same rotational alignment, and/or that
c. a semimajor axis of a base area of the main portion that faces the cone portion and a semimajor axis of a base area of the cone portion that faces the main portion are aligned so as to be mutually parallel, and/or that
d. a semiminor axis of a base area of the main portion that faces the cone portion and a semiminor axis of a base area of the cone portion that faces the main portion are aligned so as to be mutually parallel, and/or that
e. a direction of a largest diameter of a base area of the main portion that faces the cone portion and a direction of a largest diameter of a base area of the cone portion that faces the main portion are aligned so as to be mutually parallel, and/or that
f. a direction of a smallest diameter of a base area of the main portion that faces the cone portion and a direction of a smallest diameter of a base area of the cone portion that faces the main portion are aligned so as to be mutually parallel.

21. The wave generator as claimed in claim 19, wherein
a. the plug-fit element is disposed on a base area of the main portion that faces the cone portion, or wherein
b. the plug-fit counter element is disposed on a base area of the cone portion that faces the main portion.

22. The wave generator as claimed in claim 19, wherein
a. the plug-fit element and/or the plug-fit counter element have/has a non-circular external contour in cross section, or wherein
b. the plug-fit element and/or the plug-fit counter element are/is oval in cross section, or wherein
c. the plug-fit element and/or the plug-fit counter element are/is elliptic in cross section.

23. The wave generator as claimed in claim 19, wherein
a. the plug-fit element and/or the plug-fit counter element have/has an external contour different from an external contour of the main portion in cross section, or wherein
b. the plug-fit element and/or the plug-fit counter element have/has an external contour that is the same as an external contour of the main portion in cross section, wherein, however, the directions of the largest diameter are dissimilar, or wherein
c. the plug-fit element and/or the plug-fit counter element have/has an external contour that is the same as an external contour of the main portion in cross section, wherein, however, the directions of the smallest diameter are dissimilar.

24. The wave generator as claimed in claim 19, wherein the plug-fit element and the plug-fit counter element are conical.

25. The wave generator as claimed in claim 19, wherein the main portion has an axial detent that delimits the bearing seat in the axial direction, and wherein the plug-fit element is formed by an external contour of a base area of the main portion that faces away from the cone portion, and/or is formed by the axial detent.

26. The wave generator as claimed in claim 22, further comprising a retaining element connectable to the cone portion exclusively in one specific rotational alignment, wherein the retaining element includes the plug-fit counter element.

27. The wave generator as claimed in claim 26, wherein the main portion is clampable between the retaining element and the cone portion.

28. A strain wave gear comprising a wave generator including a main portion having a bearing seat for a radially flexible roller bearing.

29. The strain wave gear as claimed in claim 28, wherein the wave generator further includes a cone portion adjoining the main portion in an axial direction, wherein the cone potion tapers in a direction away from the main portion, wherein the strain wave gear further comprises:
a. a roller bearing press-fitted onto the bearing seat, or
b. two mutually parallel roller bearings press-fitted onto the bearing seat, or
c. at least one roller bearing press-fitted onto the bearing seat while using a shell area of the cone portion as a guide face.

30. A method for manufacturing a strain wave gear, the method comprising the steps of:
axially plug-fitting at least one roller bearing onto the cone portion of a wave generator as claimed in claim 1; and
subsequently push-fitting the at least one roller bearing onto the bearing seat of the main portion of the wave generator, wherein a shell area of the cone portion functions as a guide face.

31. The method as claimed in claim 30, further comprising the steps of:
removing the cone portion after push-fitting of the roller bearing onto the bearing seat; and
installing the wave generator without the cone portion in the strain wave gear.
